(19) United States
(12) Patent Application Publication
(10) Pub. No.: US 2012/0267131 A1
(43) Pub. Date: Oct. 25, 2012

(54) DEVICE FOR INSTALLING UPRIGHT SUPPORT MEMBER IN A PARTICULATE SUBSTRATE

(76) Inventor: Ulisses Russo de Oliveira, Sao Paulo, SP (BR)

(21) Appl. No.: 13/090,353

(22) Filed: Apr. 20, 2011

(51) Int. Cl. A01B 1/00

(52) U.S. Cl. 172/381

(57) ABSTRACT

The present disclosure describes a device for installing an upright support member in a particulate substrate is provided, comprising an elongated first member having proximal end and a distal end and a lumen therein of approximately constant cross-section, extending from said proximal end to said distal end, the full cross section of said lumen being open at said distal end; an elongated second member having proximal end and a distal end, the distal end slidably engageable under application of manual force in a lengthwise manner into the proximal end and within the lumen of the first member; and a third member, having a periphery, affixed to said distal end of the second member, and fitted around the periphery thereof to form a slidable seal with the lumen of the first member during insertion and withdrawal of the second member.

### BACKGROUND OF THE DISCLOSED SUBJECT MATTER

1. Field of the Disclosed Subject Matter

The disclosed subject matter is in the field of the mechanical arts, and more particularly concerns a device for installing an upright support member, for example, a beach umbrella, in a particulate substrate, for example, sand.

2. Description of Related Art

Installing a beach umbrella or like object having an upright support member into a particular substrate, e.g., sand, can be a difficult and error-prone task for a consumer. The conventional ways of performing this task are either forcefully driving the tip of the umbrella pole into the sand, perhaps twisting to gain additional insertion, or digging a hole for the umbrella pole with a shovel, and burying the distal end of the pole in the hole, perhaps with some water to firm up the sand. The results of first technique may vary, depending on the consistency of the sand and the strength and skill of the inserter, and are often unsatisfactory. The second technique, while more reliable, can be more time consuming and require the user to carry a shovel.

### SUMMARY OF THE DISCLOSED SUBJECT MATTER

In one embodiment, a device for installing an upright support member in a particulate substrate is provided, comprising an elongated first member having proximal end and a distal end and a lumen therein of approximately constant cross-section, extending from said proximal end to said distal end, the full cross section of said lumen being open at said distal end; an elongated second member having proximal end and a distal end, the distal end slidably engageable under application of manual force in a lengthwise manner into the proximal end and within the lumen of the first member; and a third member, having a periphery, affixed to said distal end of the second member, and fitted around the periphery thereof to form a slidable seal with the lumen of the first member during insertion and withdrawal of the second member.

The device may be formed separate from the upright member to be installed, and manually assembled by a user. Alternately, the upright member may be unitary, or integrally formed with the device, and configured to extend from a proximal end of the second member.

Other aspects of the disclosed subject matter will be apparent from the accompanying drawings and the detailed description that follows.

### BRIEF DESCRIPTION OF THE DRAWINGS

For a more complete understanding of the disclosed subject matter and the advantages thereof, reference is now made to the following description taken in conjunction with the accompanying drawings, wherein like reference numerals represent like parts, in which:

FIG. 1 shows one embodiment of the disclosed subject matter, in which a device for installing an upright member into a particulate substrate is separate from the upright member.

FIG. 2 shows a lengthwise cross-sectional view of the device shown in FIG. 1.

FIG. 3 shows a perspective view from the distal end of the device shown in FIG. 1, with the second (inner) member of the device fully inserted in the lumen of the outer member.

FIG. 4 shows an alternate embodiment in which the device is unitary with a beach umbrella.

FIGS. 5A-5E schematically show a sequence of actions illustrating a method of use of the device of FIG. 1.

### DETAILED DESCRIPTION OF THE PREFERRED EMBODIMENTS

The following is a detailed description of certain embodiments of the invention chosen to provide illustrative examples of how it may preferably be implemented. The scope of the invention is not limited to the specific embodiments described in the following detailed description, nor is it limited by any specific implementation, embodiment or characterization depicted in the accompanying drawings or stated or described in the invention summary or the abstract. In addition, nothing contained in this written description should be understood to imply any necessary order of steps where processes are claimed, except as may be specified by express claim language.

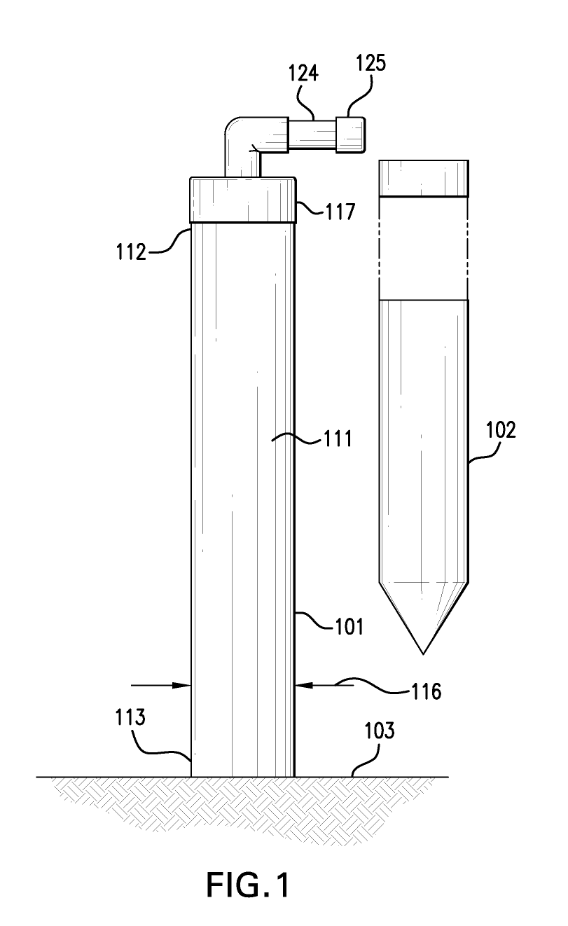

FIG. 1 shows one embodiment of the disclosed subject matter, in which a device 101 for installing an upright member 102 into a particulate substrate 103 is separate from the upright member 102. The upright member 102 may, for example, be the pole of a beach umbrella, and the particulate substrate 103 may, for example, be sand.

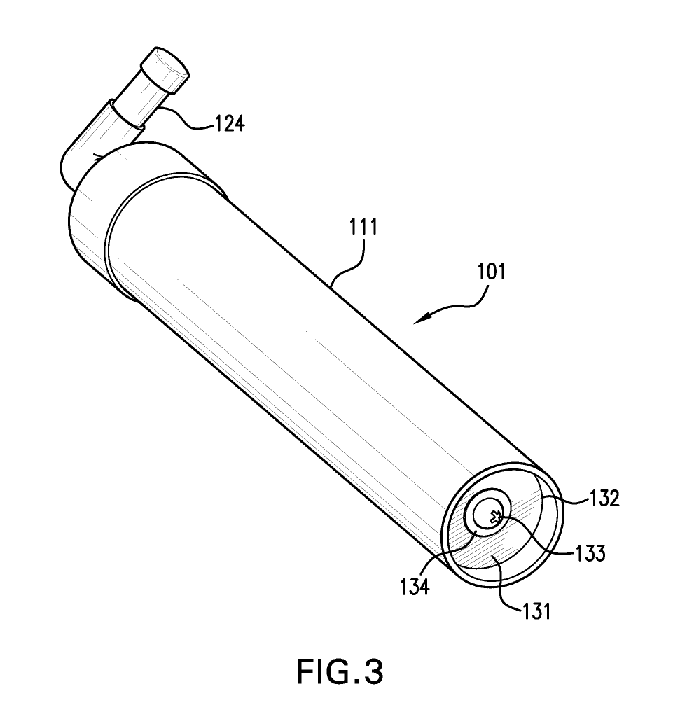

Device 101 comprises an elongated first member 111 having proximal end 112, a distal end 113, and a lumen 114 therein of approximately constant cross-section 115, extending from proximal end 112 to distal end 113. As shown in FIG. 3, which is a perspective view from the distal end of device 101, the full cross section 115 of lumen 114 is open at distal end 113.

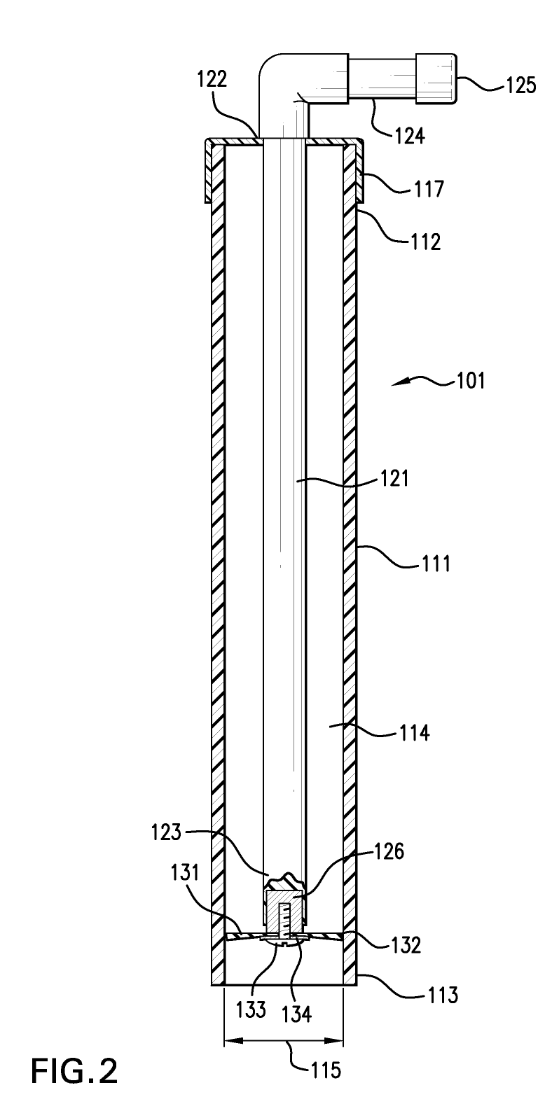

As more fully shown in FIG. 2, which is lengthwise a cross-sectional view of device 101, device 101 further comprises an elongated second member 121 having proximal end 122 and a distal end 123, the distal end 123 being slidably engageable under application of manual force in a lengthwise manner into the proximal end 112 and within the lumen 114 of the first member 111. In the embodiment illustrated in FIGS. 1-3, second member 121 may have a handle 124 at its proximal end 122.

As further shown in FIG. 2, a third member 131, having a periphery 132, affixed to the distal end 123 of the second member 121, is fitted around the periphery 132 to form a slidable seal with the lumen 114 of the first member 111, as the second member 121 is inserted and withdrawn from the first member 111.

Device 101 has been designed so that the exterior cross-section 116 of first member 111 is approximately constant from distal end 113 to about proximal end 112 of first member 111, and is approximately congruent with the presumed cross-sectional shape of the upright support member 102.

In a preferred embodiment, first member 111 may be made from thin-walled PVC tubing, for example of 1.5 inch outer diameter, and second member 121 may be made from smaller diameter PVC tubing (e.g., ¾ inch O.D.) of normal thickness. A thin wall for first member 111 assists in insertion as hereinafter described. Handle 124 may be comprised of PVC tubing and a suitable 90 degree coupling. A PVC cap 125 may be used on handle 124 and a PVC sleeve 117 may be used to centrally locate second member 121 at the proximal end of first member 111 as second member 121 slidably engages first member 111. Third member 131 may be formed from a disc of plastic foam material and affixed to second member 121 with an axial screw 133 and washer 134. Screw 133 may be secured in a suitable plug 126 affixed, for example, with an adhesive, in the distal end of second member 121, or alternately (in a variation not separately illustrated) held by a washer and nut in a hole drilled in a second PCV cap secured to the distal end of second member 121. Of course other materials and methods of construction may be substituted as will be apparent to those skilled in the mechanical arts.

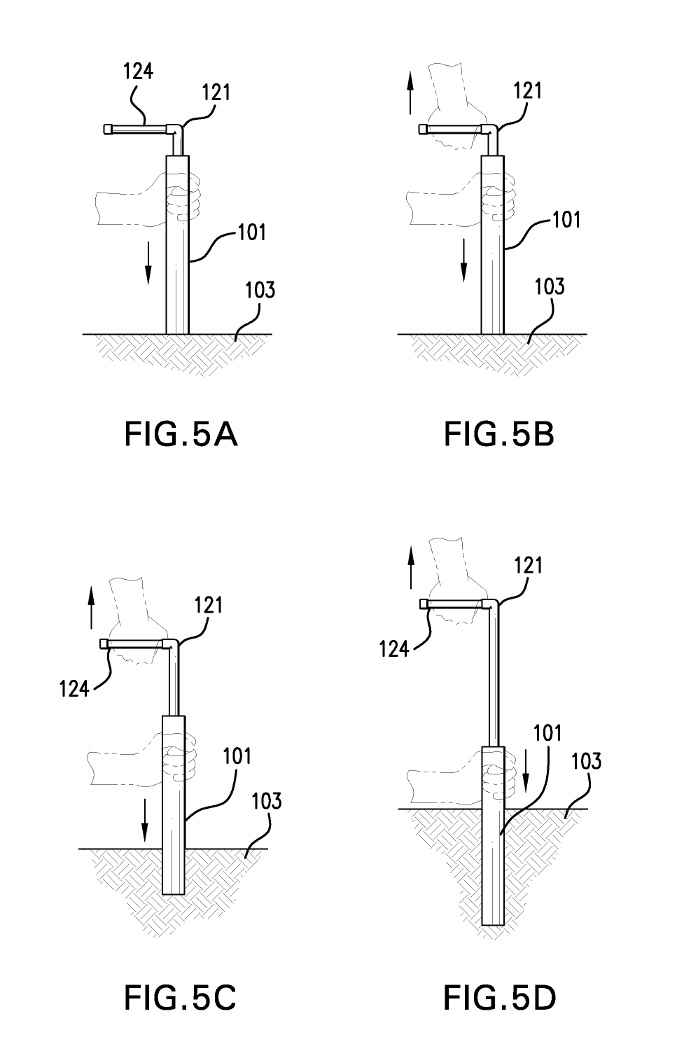

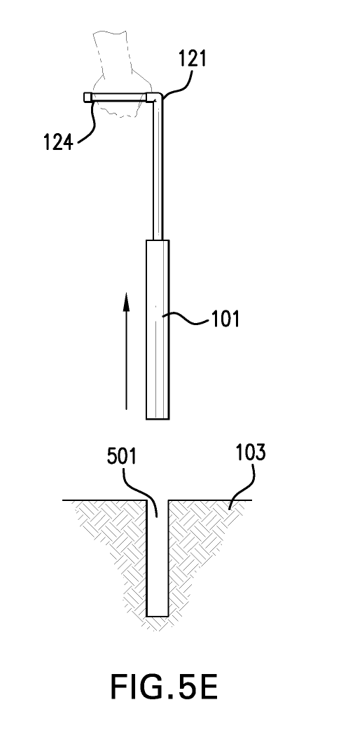

Device 102 may be used as shown in FIGS. 5A-5X. As shown in FIG. 5A, device 101 is held in an upright orientation and the distal end 113 is placed firmly into the particulate substrate 103 and grasped with one hand. Device 101 is placed in this manner with the second member 121 fully inserted in lumen 114 of first member 111. As shown in FIG. 5B, the user grasps handle 124 with the other hand, while maintaining downward pressure on the distal end of device 101 with the first hand. As shown in FIG. 5C, the user then retracts handle 124, while at the same time pushing the distal end of the first member into the particulate substrate, as far as possible, as shown in FIG. 5D. As shown in FIG. 5E, the user then pulls device 101 from the particulate substrate, leaving hole 501, and withdrawing a core of sand in lumen 114. Upright member 102 is then installed in hole 501. The user may then optionally tamp down the particulate matter surrounding hole 501, or use the sand core withdrawn by device 101 to assist in filling in or piling up around upright member 102.

Device 101 may be sold as an accessory to or aftermarket item with an article, such as a beach umbrella, incorporating upright member 102. Alternatively, device 101 may be sold as part of a package sale with a beach umbrella.

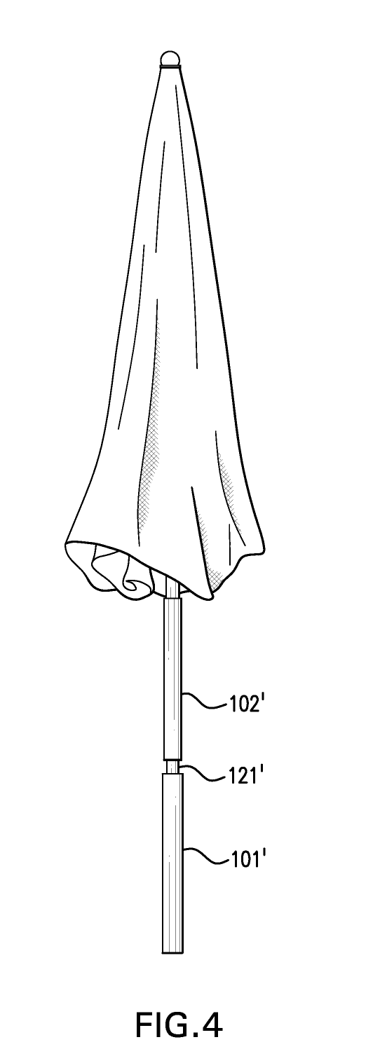

In an alternative embodiment, as shown in FIG. 4, device 101′, analogous to device 101, may be permanently or removably attached to the upright member 102′, such that upright member 102′ functions as an extension to second member 121′, and may be used as its handle for insertion.

It is apparent, therefore, that the disclosed subject matter improves over the prior art with regard to installing upright members into a particulate substrate. Although the present disclosed subject matter has been described in detail, it should be understood that various changes, substitutions, and alterations may be readily ascertainable by those skilled in the art and may be made herein without departing from the spirit and scope of the present disclosed subject matter as defined by the claims. The foregoing description of specific embodiments of the disclosed subject matter has been presented for purposes of illustration and description. It is not intended to be exhaustive or to limit the disclosed subject matter to those embodiments disclosed. Thus, it is intended that the disclosed subject matter includes modifications and variations that are within the scope of the appended claims and their equivalents.

I claim:

1. A device for installing an upright support member in a particulate substrate, comprising
an elongated first member having proximal end and a distal end and a lumen therein of approximately constant cross-section, extending from said proximal end to said distal end, the full cross section of said lumen being open at said distal end;
an elongated second member disposed within the lumen of the first member, the elongated second member having proximal end and a distal end, the distal end slidably engageable under application of manual force in a lengthwise manner into the proximal end of the lumen ; and
a third member having a periphery, the third member affixed to said distal end of the second member, and fitted around the periphery to form a slidable seal with the lumen of the first member, during insertion and withdrawal of the second member.

2. A device in accordance with claim 1, wherein the upright support member is unitary with and extends from a proximal end of the second member.

3. A device in accordance with claim 1, wherein the upright support member is separate from the device, and further wherein the outside cross-section of the first member of the device is approximately constant from the distal end to the proximal end, the cross-section of the first member of the device being congruent with the cross-sectional shape of the upright support member.

4. A device in accordance with claim 2, wherein said upright support member is the pole of a beach umbrella.

5. A device in accordance with claim 3, wherein the upright support member is the pole of a beach umbrella.

6. A device in accordance with claim 1, wherein the particulate substrate is sand.

7. A device in accordance with claim 2, wherein the upright support member is detachable from the second member.
